(19) United States
(12) Patent Application Publication
(10) Pub. No.: US 2026/0103619 A1
(43) Pub. Date: Apr. 16, 2026

(54) COMPOUNDS FOR COATING HOT PIPES

(71) Applicant: Joseph Everett PRITCHETT, Shawnee, KS (US)

(72) Inventor: Joseph Everett PRITCHETT, Shawnee, KS (US)

(21) Appl. No.: 18/917,236

(22) Filed: Oct. 16, 2024

(51) Int. Cl. C09D 183/04; C09D 7/40; C09D 7/61; C09D 133/08

(52) U.S. Cl. CPC C09D 183/04; C09D 7/61; C09D 7/69; C09D 133/08

(57) ABSTRACT

A compound for coating a steel pipe includes a resin compound including a silicone resin and a ceramic compound. The resin compound makes up about 60%-70% of the compound for coating a pipe by weight, and the ceramic compound makes up between about 30%-40% of the compound for coating a pipe by weight. The resin compound comprises about 60%-70% acrylic resin by weight, and about 30%-40% of a silicone hybrid resin compound by weight; or about 90% silicone resin by weight, and about 10% by weight of a mixture of sodium dissolved in water. The ceramic compound comprises a mixture of ceramic hollow sphere, mica and perlite. The compound for coating a pipe can be applied directly to an exterior surface of a steel pipe while the pipe is heated to a temperature ranging from at or below 32° F. to about 400° F., or about 400°F.-800°F., or about 800°F.-1,200°F.

### TECHNICAL FIELD

The present disclosure relates to compounds for coating pipes, and more particularly, to compounds for coating hot metal pipes.

### DISCUSSION OF THE RELATED ART

Pipes designed to convey hot fluids therethrough (hot pipes) are used in various industries, including oil drilling rigs in marine and land-based settings, oil extracting platforms in marine and land-based settings, power plants that burn fuel to produce electricity (generally land-based), etc. The process of conveying a hot fluid from one part of an oil rig, oil platform, power plant, etc., collectively referred to as a “rig” hereinafter, to another part of the rig via a pipe is generally required for the rig to operate normally.

Once a rig is built, it is generally intended to operate 24 hours a day for an extended period of time without interruption (e.g., weeks, months, years, etc.). The general exception is shutdown for maintenance, extreme/unforeseeable weather conditions, other environmental factors outside of human control or emergencies. Shutdowns are costly to rig owner(s)/operator(s) due to the lack of productivity of the rig coupled with the payment of wages to rig employees during the shutdown period. Therefore, it is important to eliminate or at least reduce any factor that could contribute to a rig's shutdown.

Since the usage of hot pipes is generally a required process for a rig to operate, it is desirable to ensure the longevity of the hot pipes. Since hot pipes are designed to be operated (or to carry fluid) at temperatures ranging from at/above freezing (e.g., at or above 32° F.) to about 1200° F., they are generally made of a metal. The metal of choice in most cases is carbon steel (as contrasted to stainless steel).

The problem with carbon steel pipes (hereinafter referred to as “steel” pipes for brevity purposes) is that steel corrodes from coming in contact with environmental factors such as the oxygen in air, water and other fluids such as acids and bases. The corrosion leads to rig shutdowns to replace a corroded steel pipe with a new one. Another problem with steel pipes is that they cause significant heat losses due to the relatively high thermal conductivity of steel.

These problems are addressed by the prior art by encasing the steel pipes in fiberglass, rock wool, etc., in above ground settings. While these coverings reduce heat losses along the length of the pipes, their thermal insulative properties are not high. In addition, said coverings can be easily damaged from environmental factors. The damage can include cracking/fracture that may occur from direct exposure to hail, rain and direct sun, in addition to cracking/facture that may occur from the cyclic change of environmental temperature over time, collision with airborne particles, etc. This damage can lead to corrosion in the underlying hot steel pipe when rainwater, or other fluids come in contact with the pipe through the cracks or fractures in the encasement. Moreover, the vibrations that hot pipes are exposed to in rigs are known to cause cracking or facture of the protective fiberglass and rock wool coatings.

The prior art's solution for in-ground settings is to encase the steel pipe, after it has been wrapped with fiberglass, rock wool, etc., with another metal pipe. That is, the wrapped hot pipe is inserted into a larger protective metal pipe. The larger metal pipe provides a physical protection for the wrapped hot pipe to prevent said coating from cracking or breaking due to the settlement of the ground over time, freezing and thawing of the ground, etc. The problem with this configuration is that the larger protective metal pipe causes cathodic corrosion of the hot metal pipe inside of it due to ground currents.

### SUMMARY

The present disclosure relates to coating formulations designed to address the shortcomings of the prior art in hot steel pipes used in rigs in marine and land-based settings, above and below ground. The term “coating formulation” may be used interchangeably with “a compound for coating a pipe” in this specification.

Specifically, the present disclosure relates to hot pipe coating formulations that can be used to significantly extend the service life of a hot steel pipe by preventing the cathodic corrosion of the hot steel pipe in below ground locations. This is so because the present subject matter does away with using the larger protective metal pipe in below ground settings. The prior art insulation systems of wrap and metal pipe jacketing on top of the wrap allow for what is referred to as a cathodic corrosion effect on the underlying hot metal pipe because the metal pipe jacketing allows electrical current to flow through the nested hot metal pipe, thereby creating corrosion pockets in the hot pipe.

The coating that results from the application of the compound(s) of the present subject matter prevent the occurrence of cathodic corrosion in the underlying hot metal pipe because the coating of the present disclosure is made with inert insulation ceramic compounds and resins (which are electrical insulators), and because the present subject matter omits the metal pipe jacket over the coating. Therefore, the present subject matter prevents cathodic corrosion in hot pipes under ground.

The formulations of the present subject matter contain water-based polymeric resin(s) mixed with ceramic particles. The formulations are in a flowable form, and are intended to be applied to the exterior of a steel pipe via a brush, a roller, a spraying machine, etc. Once applied, the formulations are allowed to dry to form a protective coating on the pipe.

The protective coatings that result from the drying process have a high resistivity to damage from vibration and damage in general. This is because the coatings that result from the drying of the formulations of the present disclosure exhibit a degree of elasticity that is high enough to prevent cracking, fracturing, chipping or otherwise breaking of the coating when subjected to continuous vibration and changes in environmental temperature (including extreme cold in cold climates and extreme heat in deserts and other hot climate regions), yet low enough to make the coating rigid/strong enough to prevent it from incurring structural damage when exposed to hail, rain, when colliding with airborne particles, or, for example, when subject to foreseeable loads such as when a worker may step on the coating (after it has dried), lay a tool on the coating (after it has dried), collide with the coated pipe, etc.

The high durability of the protective coatings of the present subject matter can greatly extend the service life of a hot pipe.

In addition, the coating of the present disclosure are excellent thermal insulators. Therefore, the coatings of the present subject matter can significantly reduce heat losses in hot pipes. The reduction of heat loss greatly decreases the operational costs of a rig by reducing the amount of fuel that the rig must use to keep the fluid hot inside of a pipe.

### BRIEF DESCRIPTION OF THE DRAWINGS

The above and other features of the present disclosure will become more apparent by describing in detail exemplary embodiments thereof in conjunction with the accompanying drawings, in which:

FIG. 1 is a perspective view illustrating a piping system according to an exemplary embodiment of the present disclosure;

FIG. 2 is a cross-sectional view taken along line A-A of FIG. 1;

FIG. 3 is a cross-sectional view of a piping system according to an exemplary embodiment of the present disclosure;

### DETAILED DESCRIPTION OF THE EMBODIMENTS

Exemplary embodiments of the present disclosure will be described more fully hereinafter with reference to the accompanying drawings. The present disclosure may, however, be embodied in different forms and should not be construed as being limited to the embodiments set forth herein. Like reference numerals may refer to like elements throughout the specification. The sizes and/or proportions of the elements illustrated in the drawings may be exaggerated for clarity.

When an element is referred to as being disposed on another element, intervening elements may be disposed therebetween. In addition, elements, components, parts, etc., not described in detail with respect to a certain figure or embodiment may be assumed to be similar to or the same as corresponding elements, components, parts, etc., described in other parts of the specification.

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” may include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not.

Unless defined otherwise, all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

The pipe coating compounds of the present disclosure have different formulations for different fluid temperature ranges inside of the pipe (the pipe can be presumed to have the same temperature as that of the fluid flowing inside of it).

A compound for coating a pipe, according to a first formulation of the present disclosure, is configured to be used to coat pipes conveying a fluid that ranges from at or below freezing (e.g., at or below 32° F.) to about 400° F. Stated otherwise, the compound for coating a pipe according to the first formulation (which may be referred to as the “first compound” for brevity purposes) can be applied to the exterior surface of a pipe that may reach up to 400° F. The pipe may be made of a metal (e.g., carbon steel), as described elsewhere in this specification, and the first compound may be applied directly on the exterior surface of the pipe. Alternatively, the first compound can be applied to an intervening layer on the exterior surface of the pipe, for example, the mill finish of a pipe.

The first coating compound includes a resin compound and a ceramic compound mixed with the resin compound. The resin compound may include a silicone resin. The resin compound is in a fluid form. The ceramic compound comprises a plurality of ceramic particles (or granules). The resin compound and the ceramic compound can be obtained separately and thoroughly mixed with one another to form the first coating compound. The first coating compound is flowable.

The resin compound makes up about 70% of the first compound by weight, and the ceramic compound makes up about 30% of the first compound by weight.

The resin compound comprises about 60% acrylic resin by weight, and about 40% of a silicone hybrid resin compound by weight. The acrylic resin is water-based. The acrylic resin comprises about 50% acrylic material by weight and about 50% water by weight. The acrylic material and the water are mixed with one another to form the acrylic resin.

The silicone hybrid resin compound comprises about 60% silicone resin by weight and about 40% self-crosslinking acrylic resin by weight. The silicone resin and the self-crosslinking acrylic resin are water-based. The silicone resin comprises about 60% silicone material by weight, and about 40% water by weight. The silicone material and the water are mixed with one another to form the silicone resin. The self-crosslinking acrylic resin comprises about 50% self-crosslinking acrylic material by weight and about 50% water by weight. The self-crosslinking acrylic material and the water are mixed with one another to form the self-crosslinking acrylic resin.

The ceramic compound comprises a mixture of ceramic hollow sphere (also referred to as “cenosphere”), mica and perlite. The mixture of ceramic hollow sphere, mica and perlite comprises about 10% ceramic hollow sphere particles by weight, about 20% mica particles by weight, and about 70% perlite particles by weight. The ceramic hollow sphere particles, the mica particles and the perlite particles may range from about 50 microns (or micrometers) to about 500 microns in size.

The first coating compound can be applied on the exterior of a steel pipe. As indicated elsewhere in this specification, the first coating compound can be applied directly to the exterior surface of the steel pipe to be coated. Moreover, the first coating compound can be applied to a pipe that is hot (and conducting hot fluid therethrough) when the rig is in an operational state. Therefore, composition of the first coating compound is advantageous because it enables the first coating compound to be applied to a hot pipe in a rig without shutting down the rig.

The first coating compound can be applied to a new steel pipe that will be installed in a rig or to an existing steel pipe in a rig. When applying the first coating compound to an existing pipe, the exterior surface of the pipe should be cleaned to remove any rust, oil, grease, water, ice, loose debris and/or any other foreign matter that may have accumulated on the pipe. The cleaning operation of an existing pipe can by conducted to the point of exposing bare metal on the pipe's exterior surface.

The exterior surface of new pipes should be free of oil, grease, water, ice, loose debris and/or any other foreign matter in general, but the mill/factory surface finish of the steel pipes need not be ground down to expose the bare metal underneath.

The mixture of the water-based acrylic resin and silicone hybrid resin compound, in combination with the ceramic compound in the first coating compound, results in a first layer of material, formed on the exterior surface of the pipe, that has sufficient elasticity to avoid incurring cracking, chipping and/or fracturing that occurs in conventional pipe coatings as a result of the vibrations experienced by the pipe over an extended period of time in a rig. In addition, the composition of the first coating compound makes the first layer of material sufficiently durable to withstand repeated environmental heating/cooling cycles, exposure to hail, wind, rain, collision with airborne particles, to support the weight of worker(s) and their tools, and to withstand unintended but foreseeable collisions with workers and/or other moving objects without cracking, chipping, fracturing or otherwise breaking.

In addition, the combination of the resin compound and ceramic compound in the first coating compound enables the first layer of material to adhere strongly to the exterior surface of the steel pipe, regardless of whether the first coating compound is applied to bare metal or to a mill/factory finish on a steel pipe. This configuration prevents separation between the steel pipe and the first layer of material when the hot pipe is installed and put in operation.

The ceramic compound, in combination with the resin compound in the first coating compound, produces a highly thermally insulating first layer of material on a hot pipe. This benefit is believed to be derived from the low density and low thermal conductivity of the ceramic compound particles in combination with the resin compound that binds them to a pipe.

The first coating compound can be applied to a hot pipe via a brush, a roller, a spraying machine, etc. The spraying machine can be, for example, a TexSpray RTX 2000PI Texture Sprayer made by Graco Inc. of Minneapolis, Minnesota.

The first coating compound can be applied in different thicknesses to produce a first layer of material of different thicknesses on the exterior surface of the hot pipe. Generally speaking, the thicker the first coating compound is applied on a pipe, the thicker the resulting first layer of material on the pipe will be cured/dried when the water content of the resin evaporates (e.g., when the resin hardens on the pipe). The application of the first coating compound to the exterior surface of a hot pipe is not limited to one layer. For example, a plurality of coatings of the first coating compound can be successively applied to a steel pipe, with the first coating being disposed directly on the exterior surface of the pipe (or with an intervening layer in between), and each additional coating being deposited on the previously-deposited coating below. The plurality of successive coatings of the first coating compound, on the aggregate, are deemed to form the “first layer of material” on the hot pipe. That is, even though the “first layer of material” reads in the singular form, it encompasses the plurality of sub-layers of the first coating compound deposited on one another.

The thickness of each sub-layer in the first layer of material may range, for example, and without limitation, from about 20 mils to about 200 mils. A “mil” is one thousandth of an inch.

The thicker the first layer of material is formed on the steel pipe, the greater its thermal insulating property. In addition, the thicker the first layer of material is formed on a steel pipe, the lower the surface temperature will be on the exterior surface of the first layer of material.

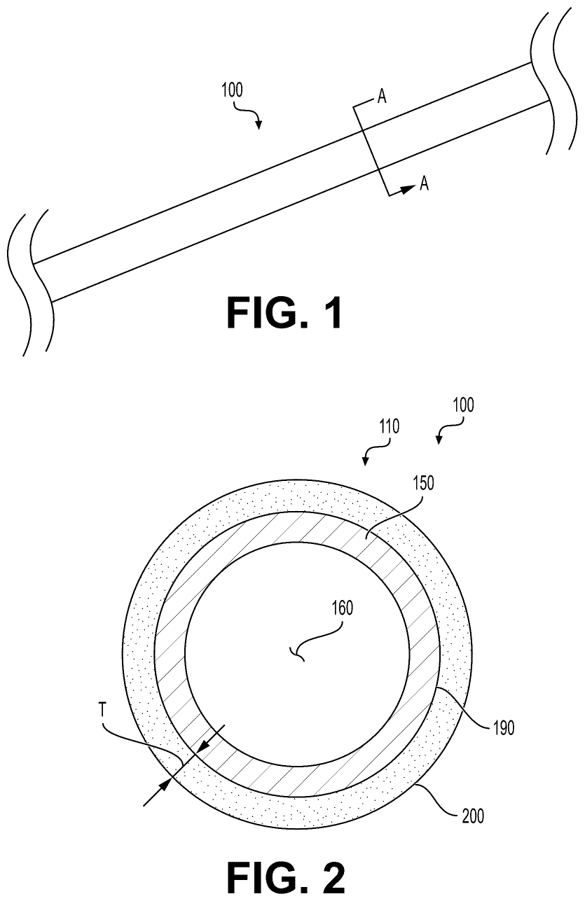

An above ground piping system where the steel pipe is configured to operate in a temperature ranging from below or at the freezing mark (e.g., from below or at 32° F.) to about 400° F. is described below with reference to FIGS. 1 and 2. The piping system of FIGS. 1 and 2 employs the first coating compound described above.

Referring to FIGS. 1 and 2, a piping system 100 includes a steel pipe 110 (e.g., a hot pipe) having a sidewall 150 defining an interior 160 of the pipe 110 and an exterior surface 190 of the pipe 110 along a length of the pipe 110. The piping system 100 may also include a first layer of material 200 formed on the exterior surface 190 of the pipe. The exterior surface 190 can be a bare metal surface or a mill/factory finish surface, as described in this specification.

The first layer of material 200 is formed by depositing the first coating compound on the exterior surface 190 of the pipe 110. As described elsewhere in this specification, the first layer of material 200 can be formed by applying the first coating compound in one layer or in a plurality of successive layers on the exterior surface 190.

The thickness T of the first layer of material 200 can vary based on considerations that include the thermal insulation needs and/or employee safety measures regarding the temperature at the exterior surface area of the first layer of material 200. This is because employees of a rig can come in direct contact with the layer of material 200 in the regular course of their duties in the vicinity of the hot pipe(s).

As an example, and without limitation, a thickness T ranging from about ¼ of an inch to about ½ of an inch (i.e., about 250 mils to about 500 mils) can satisfy both thermal insulating needs of a rig and certain employee safety regulations regarding the temperature at the exterior surface of the first layer of material 200 for pipes designed to be operated up to about 400° F. That is, a thickness T ranging from about ¼ of an inch to about ½ of an inch is not likely to burn the portion of an employee's body that comes into direct contact with the first layer of material covering a hot pipe.

The first layer of material 200 has a high resistance to vibration, a high resistance to the elements of weather and high durability against contact/collision with humans, objects, etc., as described in this specification. This is due to the composition of the first compound, as described above.

In addition, the first layer of material 200 has a high resistivity to penetration by water. Therefore, in above ground usage, no additional waterproofing needs to be applied on top of the first layer of material 200 for the purpose of preventing water (e.g., rainwater) from penetrating the first layer of material 200 and reaching the hot pipe 110.

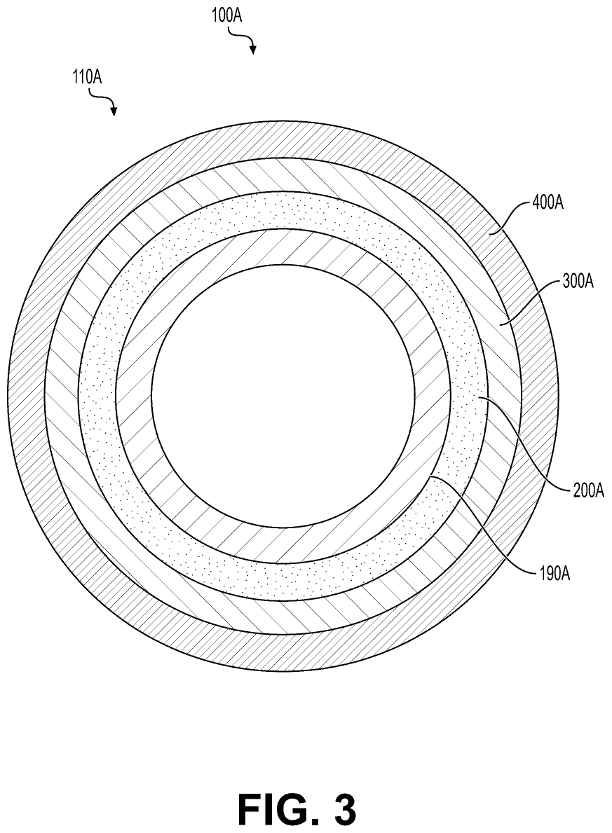

A below ground implementation of a piping system 100A will be described below with reference to FIG. 3. The piping system 100A is suitable for underground use in areas ranging from permafrost to hot desert climates.

The difference between the piping system 100 and the piping system 100A is that the piping system 100A further includes a mesh wrapping on the first coating compound and a layer of epoxy on the mesh wrapping.

Referring to FIG. 3, the piping system 100A includes a steel pipe 110A having an exterior surface 190A, a first layer of material 200A formed on the exterior surface 190, a second layer of fabric material 300A disposed on the first layer of material 200A, and a third layer of insulating material 400A disposed on the second layer of fabric material 300A.

The first layer of material 200A is the same as the first layer of material 200. Therefore, a duplicate description of its composition and method of formation on the pipe 100A will be omitted for brevity purposes.

The second layer of fabric material 300A comprises a fabric mesh. The fabric mesh may be a layer of low-density fabric. For example, the fabric mesh may be a polyester mesh. The polyester mesh may be a fine mesh. Merely as an example and without limitation, second layer of fabric material 300A may include a polyester mesh fabric layer that is about 20 mils thick and may have mesh openings of about 20 mils in size.

As illustrated in FIG. 3, the second layer of fabric material 300A may be wrapped around an exterior surface of the first layer of material 200A. Therefore, the second layer of fabric material 300A may cover the entire exterior surface of the first layer of material 200A along the length of the pipe 110A. The second layer of fabric material 300A may be disposed (e.g., wrapped) on the exterior surface of the first layer of material 200A when the first layer of material 200A is sufficiently dry (e.g., when the first layer of material 200A has cured to a sufficient degree due to the evaporation of its water content to accept the second layer of fabric material 300A thereon).

Referring to FIG. 3, the third layer of insulating material 400A comprises epoxy. The epoxy may be formed by mixing conventional two-part epoxy (e.g., Part A and Part B epoxy), into a fluid material, and applying (or disposing) the fluid epoxy on an outer surface of the second layer of fabric material 300A. As an example and without limitation, the thickness of the third layer of insulating material 400A may range from about 8 mils to about 12 mils.

The second layer of fabric material 300A reinforces the third layer of insulating material 400A (e.g., the epoxy) and the first layer of material 200A on the pipe 110A. That is, the protective structure that results on the steel pipe 100A by forming the first layer of material 200A on the steel pipe 100A, by disposing the second (mesh) layer of fabric material 300A on the first layer of material 200A, and by disposing the third layer of insulating (epoxy) material 400A on the second layer of fabric material 300A, has sufficient durability and flexibility to make it suitable for below ground use.

The epoxy in the third layer of insulating material 400A insulates the second layer of fabric material 300A, the first layer of material 200A and the pipe 110A from water, steam and/or moisture penetration. Stated otherwise, the insulating material 400A waterproofs the piping system 100A.

The first to third layers 200A, 300A, 400A can be disposed directly on one another. Alternatively, intervening layer(s) can be disposed therebetween.

The configuration of the piping system 100A is advantageous for below ground usage because it does away with the need to cover the hot pipe and its insulating material with another metal pipe, as done in the prior art. Since the additional protective metal pipe (used in the prior art) is removed, no cathodic corrosion occurs in the hot pipe 110A of the system 100A. The prevention of cathodic corrosion in the piping system 100A can greatly extend the service life of the underlying hot pipe.

In addition, the first to third layers 200A, 300A and 400A of the piping system 100A can be formed on an existing underground pipe of a rig (the ground must be dug and removed to provide access to the pipe) without shutting down the rig. This is because the first layer of material 100A can be formed by applying the first compound in a wet (flowable) form to an operational hot pipe due to the ability of the first compound to withstand being exposed to a temperature of up to about 400° F. without burning or otherwise suffering any adverse effect as a result of the temperature of the pipe. The same applies to the first layer of material 100 for pipes located above ground, the only difference being that the first compound is applied to the exterior of a pipe (heated up to about 400° F.) above ground. The first layer of material 100A may be formed of a thickness that achieves a desired thermal insulation below ground for energy efficiency purposes.

The second layer 300A can then be applied (or wrapped) around the first layer 200A, and the third layer 400A can be applied by brushing, spraying, rolling, etc., the epoxy on the second layer 300A while the rig remains operational. The exposed underground pipe can then be covered with earth material again.

In the case of a new pipe to be installed below ground, the operations above can be performed on a new steel pipe at a convenient location to produce a pipe with the layering structure as illustrated in FIG. 3. The produced pipe can then be installed underground and covered with earth material. When desired, and during the production stage, a new steel pipe can be fitted with heating elements to raise the temperature of the pipe up to about 400° F. prior to applying the first layer of material 100A on the pipe. The heating step can be performed to reduce the drying time of the first compound on the surface of the hot metal pipe since the first compound is water based, and the heat of the pipe enables the water content in the first compound to evaporate faster than at ambient temperature.

The durability and flexibility of the multi-layer structure described with reference to FIG. 3 can significantly extend the service life of an underground hot pipe and provide energy savings due to its excellent thermal insulation property.

Some steel pipes in rigs are designed to operate at temperatures that exceed 400° F. These pipes are generally used in above ground portions of a rig.

A compound for coating a pipe, according to a second formulation of the present disclosure, is configured to be used to coat steel pipes configured to operate at a temperature ranging from about 400° F. to about 800° F. The compound for coating a pipe according to the second formulation (which may be referred to as the “second compound” for brevity purposes) can be applied to the exterior surface of a pipe as described in this specification with reference to the first compound. The differences between the formulation and application technique of the first and second compounds on the exterior surface of a steel pipe will be described below in detail.

The second coating compound includes a resin compound and a ceramic compound mixed with the resin compound. The resin compound may include a silicone resin. The resin compound is in a fluid form.

The ceramic compound comprises a plurality of ceramic particles (or granules). The resin compound and the ceramic compound can be obtained separately and thoroughly mixed with one another to form the first coating compound. The second coating compound is flowable.

The resin compound makes up about 65% of the second compound by weight, and the ceramic compound makes up about 35% of the second compound by weight.

The resin compound of the second formulation comprises about 70% silicone resin by weight, and about 30% by weight self-crosslinking acrylic resin.

The silicone resin and the self-crosslinking acrylic resin in the second formulation may be water based. The silicone resin comprises about 80% silicone material by weight and about 20% water by weight. The silicone material and the water may be mixed with one another to form the silicone resin. The self-crosslinking acrylic resin comprises about 50% self-crosslinking acrylic material by weight and about 50% water by weight. The self-crosslinking acrylic material and the water are mixed with one another to form the self-crosslinking acrylic resin.

The ceramic compound of the second formulation comprises a mixture of ceramic hollow sphere, mica and perlite. The mixture of ceramic hollow sphere, mica and perlite comprises about 10% ceramic hollow sphere particles by weight, about 20% mica particles by weight, and about 70% perlite particles by weight. The ceramic hollow sphere particles, the mica particles and the perlite particles may range from about 50 microns to about 500 microns in size.

The formulation of the second compound enables the second compound to form a thermally-insulating, protective and durable coating of material when applied to the exterior surface of a steel pipe. Specifically, the second compound is configured to be applied on the exterior surface of a steel pipe (either bare metal or metal with a mill/factory finish, as described elsewhere in this specification) that is heated to a temperature in the range of about 400° F. to about 800° F.

Therefore, the second formulation does not require a rig to be shut down (so that the hot pipes can cool to room temperature) before applying the second formulation to the exterior of a steel pipe. This configuration maintains the high productivity of a rig.

The second coating compound can be applied to a hot pipe via a brush, a roller, a spraying machine, etc. The spraying machine can be, for example, a TexSpray RTX 2000PI Texture Sprayer made by Graco Inc. of Minneapolis, Minnesota.

The coating that results on a steel pipe to which the second compound is applied may be referred to as a first layer of material. The self-crosslinking acrylic resin in the second composition adheres the first layer of material strongly to the exterior surface of a pipe. In addition, the self-crosslinking acrylic resin in the second composition imparts a certain degree of flexibility in the first layer of material that makes that first layer of material resistant to pipe vibration, resistant to environmental factors and durable against collisions with human, moving objects, etc. Therefore, the first layer of material formed by using the second formulation is unlikely to crack, fracture, chip or otherwise break due to pipe vibrations and/or collision with humans and moving objects.

The first layer of material formed on a pipe by coating the pipe with the second formulation is resistant to water penetration. Therefore, and since most of the pipes in rigs heated to a temperature range of about 400° F. to about 800° F. are located above ground, there is no need to apply additional protective layer, such as the second and third layers 300A, 400A described in this specification, on the first layer of material formed by using the second formulation (for pipes located above ground).

The first layer of material formed by using the second formulation is highly thermally-insulating.

The first layer of material produced by using the second formulation should be formed on the exterior surface of a pipe by depositing a plurality of consecutive coatings of the second compound on the pipe. That is, even though the “first layer of material” reads in the singular form, it encompasses a plurality of sub-layers of the second compound stacked on top of one another.

Specifically, the second formulation should be first applied in thin coats, e.g., coats ranging rom about 20 to about 30 mils on the exterior surface of a pipe when the pipe is heated to a temperature ranging from about 400° F. to about 800° F. (i.e., when the rig is in operation). This is due to the high temperature of the pipe. The application of substantially thicker coats on such a hot pipe can lead to blistering/bubbling of the second compound as it dries on the hot pipe.

For example, the second formulation can be applied in about three or four consecutive coats, each ranging from about 20 to about 30 mils thick, to a pipe heated to a temperature ranging from about 400° F. to about 800° F. The coats are also quick drying because they are thin, and the hot temperature of the pipe causes the water content of the resins in the second formulation to evaporate quickly.

Then, thicker coats can be applied on top of the successively stacked thinner coats below. For example, about three or four coats, each of about 100 mils thick, can be applied on top of the last 20-30 mil coat.

Still thicker coats can be applied after the three or four 100 mil coats, if desired, to bring the first layer of material, as a whole, to a desired thickness.

The thickness of the first layer of material, formed by using the second compound, can be selected based on the thermal insulation needs of a rig (to reduce fuel consumption) and/or employee safety measures.

Some steel pipes in rigs are designed to operate at temperatures that exceed 800° F. These pipes are generally used in above ground portions of a rig.

A compound for coating a pipe, according to a third formulation of the present disclosure, is configured to be used to coat steel pipes configured to operate at a temperature ranging from about 800° F. to about 1200° F. The compound for coating a pipe according to the third formulation (which may be referred to as the “third compound” for brevity purposes) can be applied to the exterior surface of a pipe as described in this specification with reference to the first compound. The differences between the formulation and/or application technique of the second and third compounds on the exterior surface of a steel pipe will be described below in detail.

The third coating compound includes a resin compound and a ceramic compound mixed with the resin compound. The resin compound may include a silicone resin. The resin compound is in a fluid form. The ceramic compound comprises a plurality of ceramic particles (or granules). The resin compound and the ceramic compound can be obtained separately and thoroughly mixed with one another to form the first coating compound. The third coating compound is flowable.

The resin compound makes up about 65% of the third compound by weight, and the ceramic compound makes up about 35% of the third compound by weight.

The resin compound of the third formulation comprises about 95% silicone resin by weight, and about 5% by weight of a mixture of water and sodium dissolved in the water.

The silicone resin is pure silicone resin (e.g., about 100% water-based silicone resin). The mixture of water and sodium dissolved in the water comprises about 62% water by weight, and about 38% sodium by weight. This mixture is in the form of a viscous fluid, having about the viscosity of honey at room temperature.

The ceramic compound of the third formulation comprises a mixture of ceramic hollow sphere, mica and perlite. The mixture of ceramic hollow sphere, mica and perlite comprises about 10% ceramic hollow sphere particles by weight, about 20% mica particles by weight, and about 70% perlite particles by weight. The ceramic hollow sphere particles, the mica particles and the perlite particles may range from about 50 microns to about 500 microns in size.

The formulation of the third compound enables the third compound to form a thermally-insulating, protective and durable coating of material when applied to the exterior surface of a steel pipe. Specifically, the second compound is configured to be applied on the exterior surface of a steel pipe (either bare metal or metal with a mill/factory finish, as described elsewhere in this specification) that is heated to a temperature in the range of about 800° F. to about 1200° F.

Therefore, the third formulation does not require a rig to be shut down (so that the hot pipes can cool to room temperature) before applying the third formulation to the exterior of a steel pipe. This configuration maintains the high productivity of a rig.

The coating that results on a steel pipe to which the third compound is applied may be referred to as a first layer of material. The third compound is configured not only to provide excellent thermal insulation along a length of the pipe, but to also form a strong bond with the exterior surface of a pipe when applied to hot pipe (i.e., when the exterior surface of the pipe is heated in the range of about 800° F. to about 1200° F.).

This is because the sodium in the third formulation forms sharp and pointed crystals upon contact with the hot pipe (i.e., when the first coat of the third formulation comes in contact with the hot exterior surface of the steel pipe). The pointed and sharp crystals are believed to be formed in and fill the small (e.g., microscopic) crevices at the exterior surface of the pipe (whether on bare metal or a mill finish), and, as a result of filling the crevices and having a sharp and pointy structure, become strongly lodged in place on said crevices.

The first layer of material formed on a pipe by coating the pipe with the third formulation is resistant to water penetration. Therefore, and since most of the pipes in rigs heated to a temperature range of about 800° F. to about 1200° F. are located above ground, there is no need to apply an additional protective layer, such as the second and third layers 300A, 400A described in this specification, on the first layer of material formed by using the third formulation in above ground settings.

The first layer of material formed by using the third formulation is highly thermally-insulating.

The third coating compound can be applied to a hot pipe via a brush, a roller, a spraying machine, etc. The spraying machine can be, for example, a TexSpray RTX 2000PI Texture Sprayer made by Graco Inc. of Minneapolis, Minnesota.

The first layer of material formed by using the third formulation should be formed on the exterior surface of a pipe by depositing a plurality of consecutive coatings of the second compound on the pipe. That is, even though the “first layer of material” reads in the singular form, it encompasses a plurality of sub-layers of the third compound stacked on top of one another.

Specifically, the third formulation should first be applied in thin coats, e.g., coats ranging rom about 20 to about 30 mils on the exterior surface of a pipe when the pipe is heated to a temperature ranging from about 800° F. to about 1200° F. (i.e., when the rig is in operation). This is due to the high temperature of the pipe. The application of substantially thicker coats on such a hot pipe can lead to blistering/bubbling of the second compound as it dries on the hot pipe.

For example, the second formulation can be applied in about three or four consecutive coats, each ranging from about 20 to about 30 mils thick, to a pipe heated to a temperature ranging from about 800° F. to about 1200° F. The coats are also quick drying because they are thin, and the hot temperature of the pipe causes the water content of the resins in the second formulation to evaporate quickly.

Then, thicker coats can be applied on top of the thinner coats below. For example, about three or four coats of the third compound, each of about 100 mils, can be applied on top of the last 20 mil coat.

Still thicker coats can be applied after the three or four 100 mil coats, if desired, to bring the first layer of material, as a whole, to a desired thickness.

The thickness of the first layer of material, formed by using the third compound, can be selected based on the thermal insulation needs of a rig (to reduce fuel consumption) and/or employee safety measures.

As an example, a 30 mm (1181 mils) thick first layer of material was formed on a pipe operating at 550° C. (1022° F.) to reduce the temperature at the exterior surface of a coating to a point that was safe for a user to place the user's bare hand on the first layer of material without suffering skin burn on the hand while holding the hand against the exterior surface of the first layer of material for an extended period of time (e.g., several minutes).

The protective coatings that result from applying the first to third compounds of present disclosure are not only durable and thermally-insulating, but each one of said first to third compounds is also formulated to be applied to a hot pipe that is in operation such that a rig need not be shut down to cool the pipe to room temperature prior to carrying out the coating process.

As indicated above, it is understood that each number and each range (whether relating to the content of material in a compound or temperature), can vary up or down by 10% relative to the nominal value presented, unless otherwise indicated or inferred.

While the present disclosure has been particularly shown and described with reference to exemplary embodiments thereof, it will be apparent to those of ordinary skill in the art that various changes in form and detail may be made therein without departing from the spirit and scope of the present disclosure as defined by the following claims.

What is claimed is:

1. A compound for coating a pipe, comprising:
a resin compound that includes a silicone resin, and a ceramic compound mixed with said resin compound.

2. The compound of claim 1, wherein the resin compound makes up about 70% of the compound for coating a pipe by weight, and the ceramic compound makes up about 30% of the compound for coating a pipe by weight.

3. The compound of claim 2, wherein the resin compound comprises about 60% acrylic resin by weight, and about 40% of a silicone hybrid resin compound by weight.

4. The compound of claim 3, wherein the silicone hybrid resin compound comprises about 60% silicone resin by weight and about 40% self-crosslinking acrylic resin by weight.

5. The compound of claim 4, wherein the ceramic compound comprises a mixture of ceramic hollow sphere, mica and perlite.

6. The compound of claim 5, wherein the mixture of ceramic hollow sphere, mica and perlite comprises about 10% ceramic hollow sphere particles by weight, about 20% mica particles by weight, and about 70% perlite particles by weight.

7. The compound of claim 5, wherein a size of a particle, the particle selected from the group of particles consisting of particles of the ceramic hollow sphere, particles of the mica and particles of the perlite, ranges from about 50 microns to about 500 microns.

8. The compound of claim 1, wherein the resin compound makes up about 65% of the compound for coating a pipe by weight, and the ceramic compound makes up about 35% of the compound for coating a pipe by weight.

9. The compound of claim 8, wherein the resin compound comprises about 70% silicone resin by weight, and about 30% self-crosslinking acrylic resin by weight.

10. The compound of claim 9, wherein the ceramic compound comprises a mixture of ceramic hollow sphere, mica and perlite.

11. The compound of claim 10, wherein the mixture of ceramic hollow sphere, mica and perlite comprises about 10% ceramic hollow sphere particles by weight, about 20% mica particles by weight, and about 70% perlite particles by weight.

12. The compound of claim 8, wherein the resin compound comprises about 95% silicone resin by weight, and about 5% by weight of a mixture of water and sodium dissolved in the water.

13. The compound of claim 12, wherein the mixture of water and sodium dissolved in the water comprises about 62% water by weight, and about 38% sodium by weight.

14. The compound of claim 13, wherein the ceramic compound comprises a mixture of ceramic hollow sphere, mica and perlite.

15. The compound of claim 14, wherein the mixture of ceramic hollow sphere, mica and perlite comprises about 10% ceramic hollow sphere particles by weight, about 20% mica particles by weight, and about 70% perlite particles by weight.

16. A piping system, comprising:
a pipe having a sidewall defining an interior of the pipe and an exterior surface of the pipe along a length of the pipe;
a first layer of material formed on the exterior surface of the pipe,
wherein said first layer of material is formed by depositing a compound for coating a pipe on the exterior surface of the pipe, said compound for coating a pipe comprising:
a resin compound that includes a silicone resin; and
a ceramic compound mixed with said resin compound.

17. The piping system of claim 16, wherein the resin compound makes up about 70% of the compound for coating a pipe by weight, and the ceramic compound makes up about 30% of the compound for coating a pipe by weight,
wherein the resin compound comprises about 60% acrylic resin by weight, and about 40% of a silicone hybrid resin compound by weight,
wherein the silicone hybrid resin compound comprises about 60% silicone resin by weight and about 40% self-crosslinking acrylic resin by weight,
wherein the ceramic compound comprises a mixture of ceramic hollow sphere, mica and perlite, and
wherein the mixture of ceramic hollow sphere, mica and perlite comprises about 10% ceramic hollow sphere particles by weight, about 20% mica particles by weight, and about 70% perlite particles by weight.

18. The piping system of claim 17, further comprising:
a second layer of fabric material disposed on the first layer of material; and
a third layer of insulating material disposed on the second layer of fabric material,
wherein the second layer of fabric material comprises a fabric mesh, and
wherein the third layer of insulating material comprises epoxy.

19. The piping system of claim 16, wherein the resin compound makes up about 65% of the compound for coating a pipe by weight, and the ceramic compound makes up about 35% of the compound for coating a pipe by weight,
wherein the resin compound comprises about 70% silicone resin by weight, and about 30% self-crosslinking acrylic resin by weight,
wherein the self-crosslinking acrylic resin comprises about 50% self-crosslinking acrylic material by weight and about 50% water by weight,
wherein the ceramic compound comprises a mixture of ceramic hollow sphere, mica and perlite, and
wherein the mixture of ceramic hollow sphere, mica and perlite comprises about 10% ceramic hollow sphere particles by weight, about 20% mica particles by weight, and about 70% perlite particles by weight.

20. The piping system of claim 16, wherein the resin compound makes up about 65% of the compound for coating a pipe by weight, and the ceramic compound makes up about 35% of the compound for coating a pipe by weight,
wherein the resin compound comprises about 95% silicone resin by weight, and about 5% by weight of a mixture of water and sodium dissolved in the water,
wherein the mixture of water and sodium dissolved in the water comprises about 62% water by weight, and about 38% sodium by weight, and
wherein the ceramic compound comprises a mixture of ceramic hollow sphere, mica and perlite.
